(19) United States
(12) Patent Application Publication
(10) Pub. No.: US 2011/0111168 A1
(43) Pub. Date: May 12, 2011

(54) METHOD FOR PRODUCING A PLANAR MULTI-AXIAL COMPOSITE PRODUCT AND RESULTING PRODUCT

(75) Inventors: Gilles Duqueine, Fontaines sur Saone (FR); Jerome Aubry, Saint Baudille de la Tour (FR)

(73) Assignee: AIRBUS, Blagnac (FR)

(21) Appl. No.: 12/920,887

(22) PCT Filed: Mar. 5, 2009
(86) PCT No.: PCT/FR2009/050360

§ 371 Date: Dec. 30, 2010

(30) Foreign Application Priority Data
Mar. 7, 2008 (FR) 0801278

(51) Int. Cl. B29C 70/24; B32B 38/04; B32B 5/08; B29C 70/30

(52) U.S. Cl. 428/112; 156/250; 156/510

(57) ABSTRACT

This method of producing a planar multi-axial composite product, comprises in particular the steps consisting of:
(a) forming a mat (13) having a longitudinal direction and a transverse direction, multi-layer comprising at least the steps consisting in:
   laying up on a manufacturing support surface a first layer comprising juxtaposed tapes of unidirectional reinforcing fibers preimpregnated with resin, the tapes of the first layer presenting a first angle relative to the longitudinal direction of the mat,
   laying up on the first layer (10), at least one second layer (11, 12) comprising juxtaposed unidirectional tapes of reinforcing fibers pre-impregnated with resin, the tapes of the second layer presenting a second angle to the longitudinal direction of the mat,
(b) carrying out a compaction on the at least two layers,
(c) cutting the mat (13) into at least one planar multi-axial composite product having homogeneous deformability properties, in particular for double curvature, that allow members of complex shape to be manufactured.

This invention relates to a composite semi-finished product and a method for manufacturing this semi-finished composite product.

Currently there are essentially three main methods for manufacturing composite members and, in particular, to manufacture composite members with warped or curvilinear parts.

By “composite member” or “composite material” is meant a member or material generally made of a woven or non-woven fiber reinforcement and of a material (thermosetting or thermoplastic) that ensures the cohesion of the structure and the transmission of forces to the reinforcement.

Each method has specific advantages and associated disadvantages.

The implementation method for preimpregnates involves positioning a set of tapes consisting of unidirectional fibers or woven tapes.

In the preimpregnates method, unidirectional tapes or fabric are stacked and are polymerized under pressure.

This method allows members to be produced that exhibit a high volume fraction of fibers; this is very favorable in terms of the mechanical properties of members thus obtained.

In the case of members having a simple shape, the member can be either in unidirectional preimpregnated tapes or in preimpregnated woven fabric.

In the case of members having a complex shape, one generally uses a preimpregnated fabric, usually a 2/2 twill which can be deformed within certain limits. To optimize the mechanical performance and reduce the cost and weight of the members, a layup of unidirectional tapes can be considered; it should then have several successive layers of large amounts of juxtaposed narrow width tapes.

This method is not, however, completely suitable for producing complex members as the basic element is a planar tape and therefore unlikely to adopt shapes with complex geometry. Moreover, the manufacturing cycle time for such members can be relatively long. This method is therefore poorly suited to manufacturing members at industrial rates.

The RTM (Resin Transfer Molding) method is a method of molding under pressure in which a dry fiber preform (glass, carbon, aramid) is placed in a mold and a resin, possibly combined with body pigments, is injected into the mold. Once the resin is polymerized, the mold can be opened and the member can be removed. This method has the advantage of producing members that have two finished faces.

However, this method requires expensive molds and the preform manufacturing step is hardly compatible with the requirements of industrial rates of production.

The vacuum bag resin infusion method allows large members to be produced. This method provides a dry layup of reinforcing layers of a mold and, after leak proofing with a sealing film, the resin is transferred into the reinforcing tapes between a distribution network and one or more suction points.

This method however has the drawback of producing members that have only a single functional surface. Moreover, the members thus formed can exhibit poor resistance to interlaminar shear.

Thus, it appears that the existing methods each have functional and or industrial limitations.

Within this technical context, one aim of the invention is to provide a method for realizing semi-finished composite products that can be implemented in the manufacture of load-bearing members with complex geometries.

According to a first aspect, the invention relates to a method of manufacturing a multi-axial planar composite product, which comprises the following steps in particular:

(a) forming a mat having a longitudinal direction and a transverse direction, multi-layer comprising at least the steps consisting in:
laying up on a manufacturing support surface a first layer comprising juxtaposed tapes of unidirectional reinforcing fibers preimpregnated with resin, the tapes of the first layer presenting a first angle relative to the longitudinal direction of the mat,
laying up on the first layer, at least one second layer comprising juxtaposed unidirectional tapes of reinforcing fibers preimpregnated with resin, the tapes of the second layer presenting a second angle to the longitudinal direction of the mat,

(b) carrying out a compaction on the at least two layers,

(c) cutting the mat into at least one multi-axial planar composite product having deformability properties that allow members of complex shape to be manufactured.

The invention thus proposes to manufacture a composite product by a method which can be largely automated; a critical point of the semi-finished product obtained by the method according to the invention is its deformability resulting from its multi-layer structure within which sliding between and inside the tapes is possible. This capability can be implemented for the realization of members with complex shapes, e.g. showing progressive curvatures and/or curves with double curvature. It is stated that the composite product according to the invention can be manufactured in an automated way in one location, then be transported to a second location, which may be distant, to be implemented in a method in which the composite product is deformed.

According to an advantageous embodiment of the invention, step (a) of forming the mat comprises the step of:
laying up, on the second layer, a third layer comprising juxtaposed unidirectional tapes of reinforcing fibers preimpregnated with resin, said layers presenting a third angle to the longitudinal direction of the mat.

Thus, the semi-finished product obtained is a tri-layer product.

The implementation method according to the invention provides that the layup of the first layer is realized with an angular orientation of between 10° and 90° in relation to the longitudinal direction of the mat.

The layup of the second layer is realized with an angular orientation equal to 90° in relation to the longitudinal direction of the mat.

The layup of the third layer is realized with an angular orientation of between −10° and −90° in relation to the longitudinal direction of the mat.

According to one possibility, the method may include the steps of laying up an even number of layers arranged on either side of a central plane separating the mat in two, the two layers of the same rank relative to said plane being oriented according to opposite angles. By “opposite angles” is meant angles whose absolute values are identical but whose orientations are opposite in relation to the longitudinal direction of the mat. Thus, as an example, a layer having an orientation of +30° and a layer having an orientation of −30° in the meaning of this document means that the first layer forms an angle of +30° relative to the longitudinal direction of the mat and the second layer forms an angle of −30° or +150° relative to the longitudinal direction of the mat.

Also, steps may be considered of laying up an even number of layers arranged on either side of a central plane separating the mat in two, the two layers of the same rank relative to said plane being oriented according to identical angles.

According to another possibility, the method comprises the steps of laying up an even number of layers arranged on either side of a central layer oriented at 90° relative to the longitudinal direction of the mat, the two layers of the same rank relative to the central layer being oriented according to opposite angles.

It is provided that the tapes of unidirectional preimpregnated reinforcing fibers are laid up on a support, which moves continuously along the longitudinal direction of the mat.

Concretely, the method can provide for the formation of a mat with a width of about 2,000 mm.

According to a second aspect, the invention relates to a device comprising, in particular, a conveyor presenting a support surface moving continuously and at least two devices for dispensing tapes oriented relative to the conveyor according to the first angle and to the second angle, respectively.

Further, it can be provided that the device comprises a third tape dispensing device oriented according to the third angle.

In addition, the device has means for cutting the mat into a multilayered product.

According to a third aspect, the invention relates to a composite semi-finished multi-axial product obtained by the method described above comprising at least two superimposed layers of unidirectional preimpregnated reinforcing fibers oriented respectively according to angles between 10° and 90°.

The product according to the invention is therefore free of tapes oriented at 0° that is to say, is free of tapes oriented in its longitudinal direction. This disposition turns out to be important to the product's ability to deform as it is thus possible to deform it to adopt a warped shape by using the tapes' and fibers' ability to slide between themselves and by exercising the deformation preferably in a direction perpendicular to the longitudinal direction of the product. The semi-finished multi-axial composite product according to the invention is free of fibers arranged in its longitudinal direction which could prevent its smooth deformation when it is utilized in manufacturing a complex member, curvilinear or with double curves, in particular. Thus, after deformation, the fiber fraction remains high and homogeneous in all points of the product.

According to one possibility, the semi-finished multi-axial composite product comprises an even number of layers arranged on either side of a central plane separating the layers in two, the two layers of the same rank relative to said plane being oriented according to opposite angles.

According to another possibility, the semi-finished multi-axial composite product comprises an even number of layers arranged on either side of a central layer oriented at 90° relative to the longitudinal direction of the product, the two layers of the same rank relative to the central layer being oriented according to opposite angles.

Preferably, the composite semi-finished product comprises a superposition of:
a first layer comprising juxtaposed unidirectional tapes of reinforcing fibers preimpregnated with resin, said layers presenting a first angle to the longitudinal direction of the product,
a second layer comprising juxtaposed unidirectional tapes of reinforcing fibers preimpregnated with resin, said layers presenting a second angle to the longitudinal direction of the product,
a third layer comprising juxtaposed unidirectional tapes of reinforcing fibers preimpregnated with resin, said layers presenting a third angle to the longitudinal direction of the product.

It is, in addition, provided that the first layer is oriented according to an angle of between 10° and 90° in relation to the longitudinal direction of the product, that the second layer is oriented at an angle equal to 90° to the longitudinal direction of the product, that the third layer is oriented at an angle opposite to the angle of the first layer between −10° and −90° to the longitudinal direction of the product.

In a preferred manner, the unidirectional fibers taking part in the composition of the product according to the invention are carbon fibers preimpregnated with thermosetting or thermoplastic resin, which allows the semi-finished product, after a subsequent stage, to be used as a load-bearing member, in aeronautical applications in particular.

For proper understanding, the invention is described with reference to the drawing appended hereto representing, as a non-exhaustive example, several embodiments of the manufacturing method of a multi-axial planar composite product according to it.

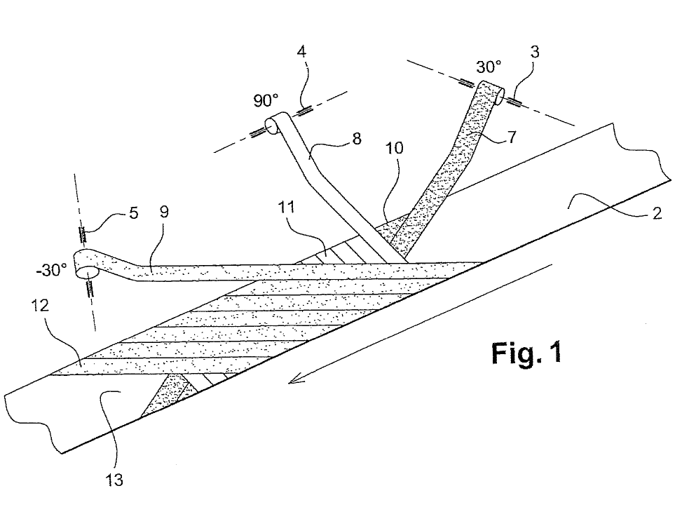

FIG. 1 is a schematic view representing an embodiment of the method,

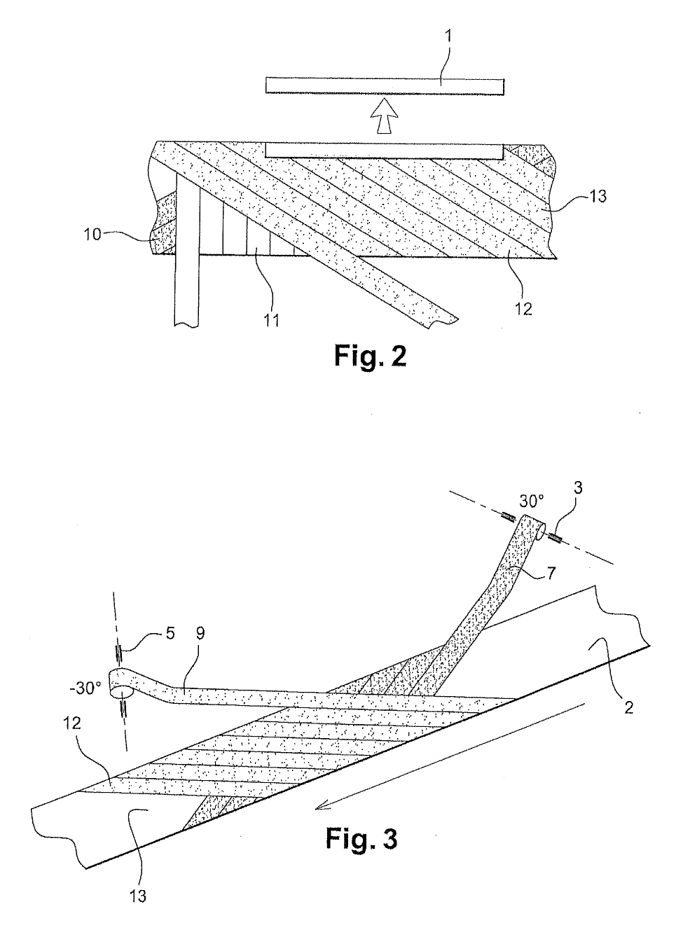

FIG. 2 is a top view of the composite product during manufacturing,

FIG. 3 is a schematic view representing a second embodiment of the method.

FIG. 1 shows schematically a device for implementing the method according to the invention.

The device includes, therefore, a conveyor belt 2 and three devices 3, 4, 5 for unwinding unidirectional preimpregnated fiber reinforcing tapes 7, 8, 9. These devices 3, 4, 5 for unwinding the unidirectional fiber reinforcing tapes 7, 8, 9 are oriented precisely in relation to the conveyor 2.

In the example shown, there are three of theses unwinding devices 3, 4, 5 which are oriented at +30°, 90° and −30° respectively relative to the direction of travel of the conveyor 2.

The unwinding devices 3, 4, 5 may be reels or other systems for delivering a tape. The unwinding devices 3, 4, 5 may comprise electric servo-motors allowing a specified length of tape do be unwound.

In manual or automatic manner, a first layer 10 of tapes of unidirectional reinforcing fibers preimpregnated with resin is deposited on the conveyor 2. In the embodiment shown in FIG. 1, this first layer 10 is oriented at an angle of 30° to the direction of movement of the conveyor. The direction of movement of the conveyor will constitute the longitudinal direction of a mat 13 which will be obtained by stacking successive layers of unidirectional tapes of preimpregnated reinforcing fibers.

As the conveyor advances, tapes from the first layer 10 are juxtaposed at an angle of 30° relative to the direction of movement of the conveyor 2.

Each tape 7, 8, 9 of unidirectional preimpregnated reinforcing fibers is cut to the width of conveyor that will form the width of the mat 13 obtained by the method according to the invention.

At a following station, downstream in the direction of movement of the conveyor, there is a second device 4 for dispensing tapes of unidirectional preimpregnated reinforcing fibers which forms an angle of 90° with the direction of movement of the conveyor 2.

Following the same principle, tapes 8 of unidirectional preimpregnated reinforcing fibers are juxtaposed to form the second layer 11 of the mat. These tapes 8 are cut to the width of the conveyor.

A third station for dispensing tapes of unidirectional preimpregnated reinforcing fibers, which is located downstream of the previous station, is oriented at an angle of −30° relative to the direction of travel of the conveyor.

Following the same principle, a third layer 12 of tapes 9 of unidirectional preimpregnated fibers is formed by juxtaposition of unidirectional tapes of fibers.

A step of compaction of the mat formed of the three layers thus specified is provided downstream from the dispensing stations. This stage of compaction can be achieved by passing the mat between two rollers, optionally heated. The compaction step can also be performed by placing the table in a vacuum with possibly a passage in an oven at a temperature between 20° C. and 70° C.

The mat 13 made up of these three layers is then, according to the invention, cut into single products 1 whose width can be equal to 150 mm and whose length can be equal to the length of the table i.e. up to 10 m.

The elements thus formed are trilayer elements incorporating triaxially oriented fibers.

This planar multi-axial composite element can then be used and be deformed into warped shapes to be implemented in U-, Z-, C-, or in omega-shaped reinforcing-type elements which, moreover, have a non-linear curve.

Of course, the invention is not limited to the embodiment described above but instead it encompasses all variant embodiments.

It is particularly envisaged to implement the method for a mat comprising two layers of tapes of unidirectional preimpregnated fibers oriented to opposed angles in relation to the longitudinal direction of the mat. Unlike the example of realization shown in FIG. 1, the mat thus formed does not require a middle layer oriented at 90°. FIG. 3 illustrates this implementation of the invention in which two layers of tapes are superimposed; in the example shown, the tapes of unidirectional preimpregnated fibers of the first layer form an angle of 30° with the longitudinal direction of the product, whereas the tapes of unidirectional preimpregnated fibers of the second layer form an angle of −30° with the longitudinal direction of the product.

It is also noted that the invention can be implemented with a number of layers equal to 2, 4, 6, 8 etc. arranged on either side of a central layer oriented at 90° relative to the longitudinal direction of the mat thus formed (case of a mat comprising an odd number of layers) or arranged on both sides of a plane of symmetry (case of a mat comprising an even number of layers without a central layer), given that within a pair of layers of same rank with respect to the central layer or to the plane of symmetry, the tapes of these layers are oriented in opposite angles.

It can also be envisaged that one or several layers other than the central layer be itself oriented at 90° relative to the longitudinal direction of the product.

1. A method for producing a multi-axial planar composite product (1), characterized in that it comprises the following steps in particular:
(a) forming a mat (13) having a longitudinal direction and a transverse direction, multi-layer comprising at least the steps consisting in:
laying up on a manufacturing support surface a first layer comprising juxtaposed tapes of unidirectional reinforcing fibers preimpregnated with resin, the tapes of the first layer presenting a first angle relative to the longitudinal direction of the mat,
laying up on the first layer (10), at least one second layer (11, 12) comprising juxtaposed unidirectional tapes of reinforcing fibers pre-impregnated with resin, the tapes of the second layer presenting a second angle to the longitudinal direction of the mat,
(b) carrying out a compaction on the at least two layers,
(c) cutting the mat (13) into at least one multi-axial planar composite product having homogeneous deformability properties, in particular for double curvature, that allow members of complex shape to be manufactured.

2. A method according to claim 1, characterized in that the step (a) of formation of the mat comprises the step consisting of:
laying up on the second layer, a third layer (12) comprising juxtaposed unidirectional tapes of reinforcing fibers preimpregnated with resin, said layers presenting a third angle to the longitudinal direction of the mat.

3. A method according to claim 1, characterized in that the layup of the first layer (10) is realized with an angle of between 10° and 90° relative to the longitudinal direction of the mat.

4. A method according to claim 1, characterized in that the layup of the second layer (11) is realized with an angle equal to 90° relative to the longitudinal direction of the mat.

5. A method according to claim 2, characterized in that the layup of the third layer (12) is realized with an angle of between −10° and −90° relative to the longitudinal direction of the mat.

6. A method according to claim 1, characterized in that it comprises the steps of laying up an even number of layers arranged on either side of a central plane separating the mat in two, the two layers of the same rank relative to said plane being oriented according to opposite angles.

7. A method according to claim 1, characterized in that it comprises the steps of laying up an even number of layers arranged on either side of a central plane separating the mat in two, the two layers of the same rank relative to said plane being oriented according to identical angles.

8. A method according to claim 1, characterized in that it comprises the steps of laying up an even number of layers arranged on either side of a central layer oriented at 90° relative to the longitudinal direction of the mat, the two layers of a same rank relative to the central layer being oriented according to opposite angles.

9. A method according to claim 1, characterized in that the preimpregnated reinforcing tapes are laid up on a support, which moves continuously along the longitudinal direction of the mat.

10. A method according to claim 1, characterized in that it can provide for the formation of a mat (13) with a width of about 2,000 mm.

11. A device for the implementation of the method according to claim 1, characterized in that the device comprises, in particular, a conveyor (2) presenting a support surface moving continuously and at least two devices (3,5) for dispensing tapes oriented relative to the conveyor according to the first angle and to the second angle, respectively.

12. A device according to claim 11, characterized in that it comprises a third tape dispensing device (4) oriented according to the third angle.

13. A device according to claim 11, characterized in that it comprises means for cutting the mat into a semi-finished multilayer product.

14. A semi-finished multi-axial composite product obtained by a method according to claim 1, characterized in that it comprises at least two superimposed layers (10, 11) of preimpregnated unidirectional reinforcing fibers oriented at angles between 10° and 90°, respectively.

15. A semi-finished multi-axial composite product according to claim 14, characterized in that it comprises an even number of layers arranged on either side of a plane separating the layers in two, the two layers of a same rank relative to said plane being oriented according to opposite angles.

16. A semi-finished multi-axial composite product according to claim 14, characterized in that it comprises an even number of layers arranged on either side of a central layer (11) oriented at 90° relative to the longitudinal direction of the product, the two layers of a same rank relative to the central layer being oriented according to opposite angles.

17. A semi-finished multi-axial composite product according to claim 15, characterized in that it comprises a superposition of:
a first layer (10) comprising juxtaposed unidirectional tapes of reinforcing fibers preimpregnated with resin, said layers presenting a first angle to the longitudinal direction of the product,
a second layer (11) comprising juxtaposed unidirectional tapes of reinforcing fibers preimpregnated with resin, said layers presenting a second angle to the longitudinal direction of the product,
a third layer (12) comprising juxtaposed unidirectional tapes of reinforcing fibers preimpregnated with resin, said layers presenting a third angle to the longitudinal direction of the product.

18. A semi-finished multi-axial composite product according to claim 17, characterized in that the first layer is oriented according to an angle of between 10° and 90° in relation to the longitudinal direction of the product, in that the second layer is oriented at an angle equal to 90° relative to the longitudinal direction of the product, in that the third layer is oriented at an angle opposed to the angle of the first layer between −10° and −90° relative to the longitudinal direction of the product.

19. A semi-finished multi-axial composite product according to claim 14, characterized in that the unidirectional fibers are carbon fibers pre-impregnated with thermosetting or thermoplastic resin.
